(19) United States
(12) Patent Application Publication
(10) Pub. No.: US 2015/0276031 A1
(43) Pub. Date: Oct. 1, 2015

(54) ROTATION AND STOP RETENTION SWITCHING APPARATUS

(71) Applicant: AISIN SEIKI KABUSHIKI KAISHA, Kariya-shi (JP)

(72) Inventors: Ryusei SUZUKI, Chiryu-shi (JP); Toshiyuki SAKAI, Kariya-shi (JP); Yasuo IMATOMI, Northville, MI (US); Yoshihiro OJI, Chita-gun (JP)

(73) Assignee: AISIN SEIKI KABUSHIKI KAISHA, Kariya-shi (JP)

(21) Appl. No.: 14/630,087

(22) Filed: Feb. 24, 2015

(30) Foreign Application Priority Data
Mar. 31, 2014 (JP) 2014-070908

(51) Int. Cl. F16H 25/24; E05F 15/622

(52) U.S. Cl. CPC F16H 25/2454; E05F 15/622

(57) ABSTRACT

A rotation and stop retention switching apparatus includes a rotary member being rotary driven, a slider being movable in an axial direction of a rotary axis of the rotary member, a transmission member transmitting a rotary force of the rotary member to the slider, a biasing member biasing the slider in the axial direction of the rotary axis, and a stopper member coming in contact with the slider being biased by the biasing member. The rotary force of the rotary member is transmitted to the slider via the transmission member in a state where the slider is disengaged from the stopper member by a movement of the slider in the axial direction of the rotary axis, the movement caused by the translational force of the slider with a use of the transmission member against a biasing force of the biasing member.

### CROSS REFERENCE TO RELATED APPLICATIONS

This application is based on and claims priority under 35 U.S.C. §119 to Japanese Patent Application 2014-070908, filed on Mar. 31, 2014, the entire content of which is incorporated herein by reference.

### TECHNICAL FIELD

This disclosure generally relates to a rotation and stop retention switching apparatus.

### BACKGROUND DISCUSSION

A spindle for a powered-back door (PBD) for a vehicle which allows to open and close a vehicle door by a manual operation and by an automatic operation by a transmission of human power or rotary power of a drive motor with the use of a spindle has been required. In addition, the spindle for the powered-back door (PBD) for the vehicle which allows to hold the vehicle door in a stopped state desirably regardless of a degree of opening of the vehicle door has been required.

A known spindle for a powered-back door (PBD) employs a freely-stoppable structure which can stop a door desirably regardless of a degree of opening of the door by the stopping and holding of the door in a stopped state by, for example, a cogging torque of a drive motor, a resistance force of a gear and a holding power of a screw.

According to a rotation and stop retention switching apparatus disclosed in DE202007015597U (hereinafter referred to as Patent reference 1), a rotary member rotates, stops and holds in a stopped state by a resistance force generated by frictional engagement between a torsion coil spring and a member. The rotation and stop retention switching apparatus is mounted to a spindle for a powered-back door (PBD) so that a door can be opened, closed, or held in the stopped state by a manual operation or an automatic operation.

According to the aforementioned spindle for the powered-back door (PBD), a heavy door cannot be stopped and held in the stopped state because of an insufficient holding force applied by the cogging torque of the drive motor and the resistance force of the gear. The holding force of the screw is required to increase in order to increase the holding force of the door in the stopped state. A lead length of the screw should be shortened to increase the holding force of the screw, however, in those circumstances, the opening and closing speed of the door decreases.

According to the rotation and stop retention switching apparatus as disclosed in Patent reference 1, it is difficult to release the friction engagement over the engagement portion in order to rotate the rotary body, and the resistance force generated by the friction engagement still exists partially. Thus, the outputted rotary force decreases and a drive motor is required to be upsized if used.

A need thus exists for a rotation and stop retention switching apparatus which is not susceptible to the drawback mentioned above.

### SUMMARY

According to an aspect of this disclosure, a rotation and stop retention switching apparatus includes a rotary member being rotary driven, a slider being movable in an axial direction of a rotary axis of the rotary member, a transmission member transmitting a rotary force of the rotary member to the slider and converting the rotary force of the rotary member into a translational force of the slider in the axial direction of the rotary axis, a biasing member biasing the slider in the axial direction of the rotary axis, and a stopper member coming in contact with the slider being biased by the biasing member. The rotary force of the rotary member is transmitted to the slider via the transmission member in a state where the slider is disengaged from the stopper member by a movement of the slider in the axial direction of the rotary axis, the movement caused by the translational force of the slider with a use of the transmission member against a biasing force of the biasing member.

According to another aspect of this disclosure, a spindle includes the rotation and stop retention switching apparatus including a rotary member being rotary driven, a slider being movable in an axial direction of a rotary axis of the rotary member, a transmission member transmitting a rotary force of the rotary member to the slider and converting the rotary force of the rotary member into a translational force of the slider in the axial direction of the rotary axis, a biasing member biasing the slider in the axial direction of the rotary axis, and a stopper member coming in contact with the slider being biased by the biasing member. The rotary force of the rotary member is transmitted to the slider via the transmission member in a state where the slider is disengaged from the stopper member by a movement of the slider in the axial direction of the rotary axis, the movement caused by the translational force of the slider with a use of the transmission member against a biasing force of the biasing member. The spindle further includes a screw being connected to the slider.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a sectional view of a rotation and stop retention switching apparatus mounted to a spindle for a powered-back door (PBD) according to a first embodiment disclosed here;

FIG. 2 is an exploded perspective view of the rotation and stop retention switching apparatus according to the first embodiment;

FIG. 3A is a perspective view of the rotation and stop retention switching apparatus according to the first embodiment;

FIG. 3B is a top view of the rotation and stop retention switching apparatus according to the first embodiment;

FIG. 4 is a cross sectional view of the rotation and stop retention switching apparatus of the first embodiment taken along line IV-IV in FIG. 3B;

FIG. 5A is a view of the rotation and stop retention switching apparatus in a state where a drive motor is in a stopped state according to the first embodiment;

FIG. 5B is a view of the rotation and stop retention switching apparatus in a state where the drive motor is in a rotary state according to the first embodiment;

FIG. 6 is an exploded perspective view of a rotation and stop retention switching apparatus according to a second embodiment;

FIG. 7 is a perspective view of the rotation and stop retention switching apparatus according to the second embodiment;

FIG. 8A is a perspective view of a slider provided at the rotation and stop retention switching apparatus of the second embodiment;

FIG. 8B is a perspective view of a shaft provided at the rotation and stop retention switching apparatus of the second embodiment;

FIG. 9 is a cross sectional view of the rotation and stop retention switching apparatus of the second embodiment taken along line IX-IX in FIG. 7;

FIG. 10A is a view of the rotation and stop retention switching apparatus in a state where the drive motor is in the stopped state according to the second embodiment; and

FIG. 10B is a view of the rotation and stop retention switching apparatus in a state where the drive motor is in the rotary state according to the second embodiment.

### DETAILED DESCRIPTION

A rotation and stop retention switching apparatus according to an embodiment will be explained with reference to the drawings. Hereinafter, the rotation and stop retention switching apparatus is referred to as a switching apparatus. The drawings may be depicted in different scales to facilitate an easy understanding.

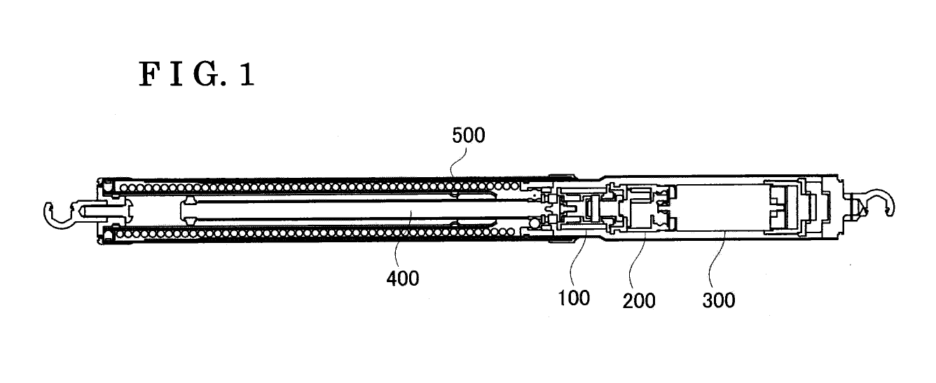

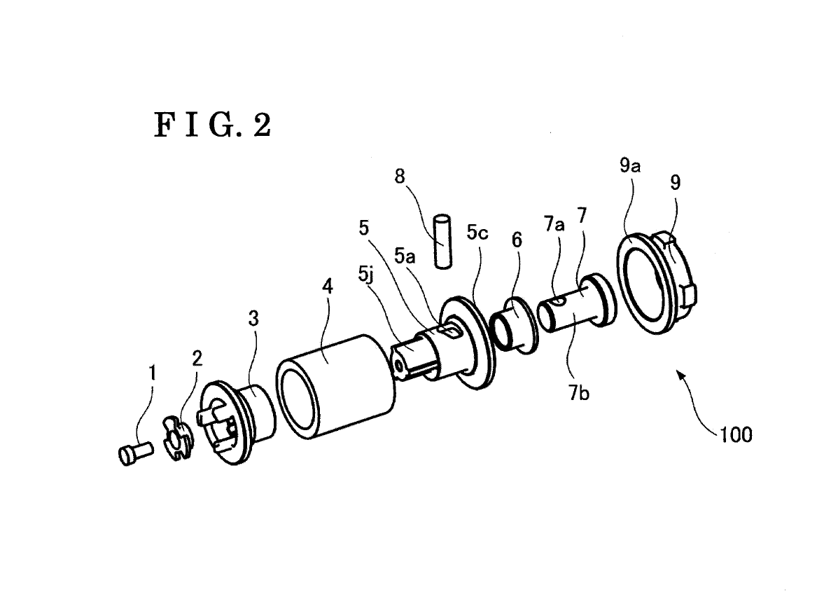

Similarly to a known spindle for a powered-back door (PBD), as shown in FIG. 1, a spindle 500 for a powered-back door (PBD) includes both end portions which are mounted to a back door (tailgate) of a vehicle and a vehicle body, respectively. A drive motor 300 rotates and transmits rotary power to a screw 400 via a switching apparatus 100 and a planetary gear (a gear) 200. When the screw 400 rotates, the spindle 500 for the powered-back door (PBD) extends and contracts in a longitudinal direction to open and close the back door (tailgate) of the vehicle.

According to the embodiment, the spindle 500 for the powered-back door (PBD) includes the switching apparatus 100, which corresponds to a feature of this disclosure.

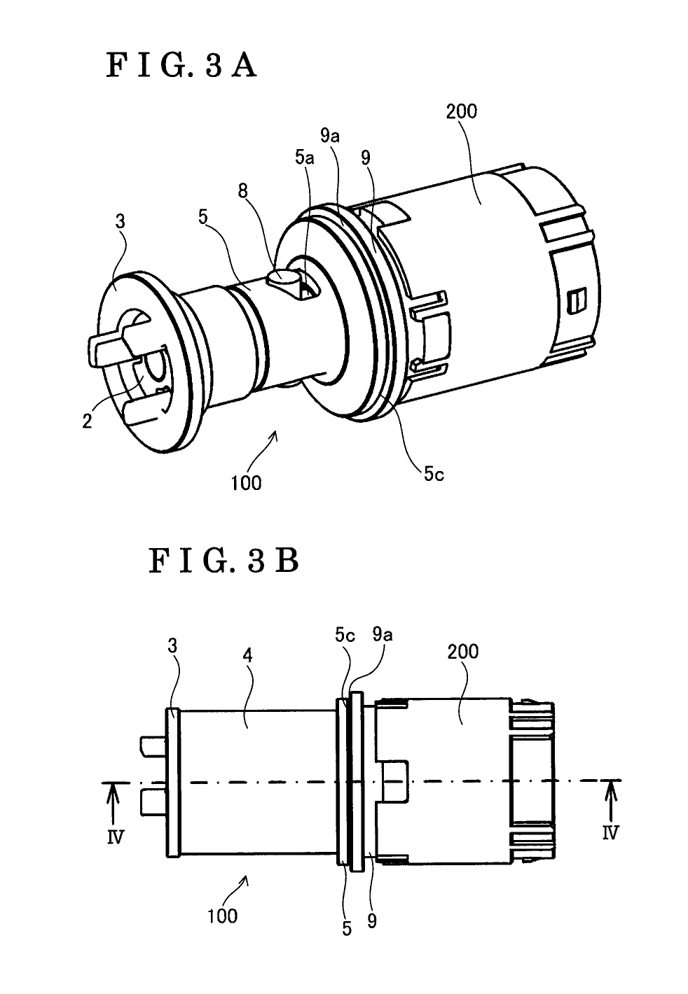

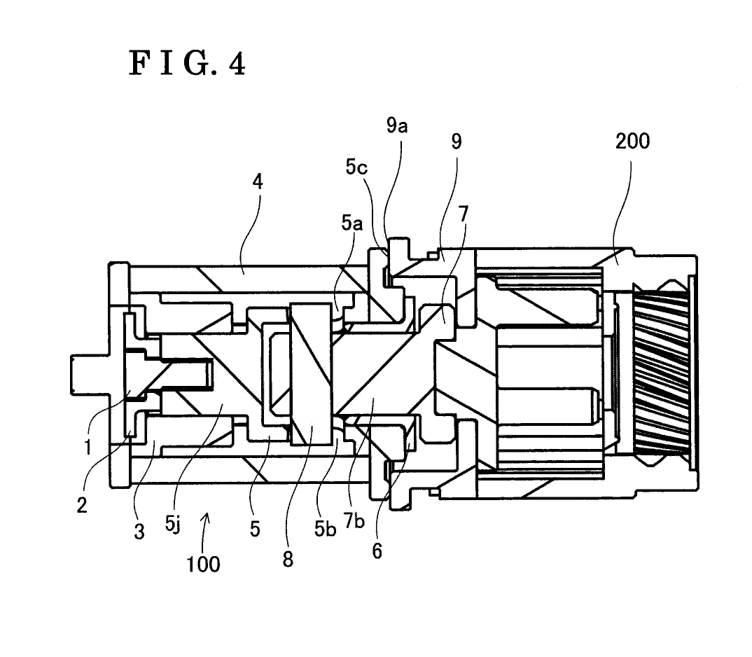

FIGS. 3 and 4 illustrate the planetary gear 200 connected to the switching apparatus 100.

The switching apparatus 100 includes a bolt 1, a first stopper 2, a coupling 3, a spring 4 (i.e., serving as a biasing member), and a slider 5. The switching apparatus 100 further includes a bush 6, a shaft 7 (i.e., serving as a rotary member), a pin 8 (i.e., serving as a transmission member) and a second stopper 9 (i.e., serving as a stopper member).

The bolt 1 is threaded in a threaded hole of a shaft portion 5j of the slider 5 so that the first stopper 2 is in contact with and fixed to the slider 5. The first stopper 2 prevents the coupling 3 from being disengaged from the switching apparatus 100.

The coupling 3 is fitted to an outer peripheral portion of the shaft portion 5j of the slider 5 so that the coupling 3 and the slider 5 are relatively slidable with each other. The spring 4 is formed in a cylindrical shape and extending along an axial direction of the shaft 7. The spring 4 is disposed between the coupling 3 and the slider 5 and biasing the slider 5 in the axial direction toward the second stopper 9.

The slider 5 includes each of first and second pin sliding grooves 5a, 5b (i.e., serving as a pin receiving portion) being provided to be penetrated from an outer peripheral surface of a hollow portion of the shaft portion 5j to an inner peripheral surface of the shaft portion 5j in a radial direction and facing each other. The bush 6 is press-fitted and fixed to the slider 5 and rotatably guides the shaft 7.

The shaft 7 is provided with a shaft portion 7b which is disposed within the hollow portion of the shaft portion 5j of the slider 5. The shaft portion 7b guides the slider 5 in the axial direction. The shaft 7 is provided with a through hole 7a which is provided within the solid shaft portion 7b in the radial direction. The shaft 7 is fixed to the planetary gear mechanism 200.

In a state where the first pin sliding groove 5a of the slider 5, the through hole 7a of the shaft 7 and the second pin sliding groove 5b of the slider 5 are aligned in line, the pin 8 is disposed in the first and second pin sliding grooves 5a, 5b and the through hole 7a and is press-fitted and fixed into the through hole 7a of the shaft 7. Accordingly, the pin 8 rotates or pivotally moves with the shaft 7. The second stopper 9 is fitted and fixed to the planetary gear mechanism 200.

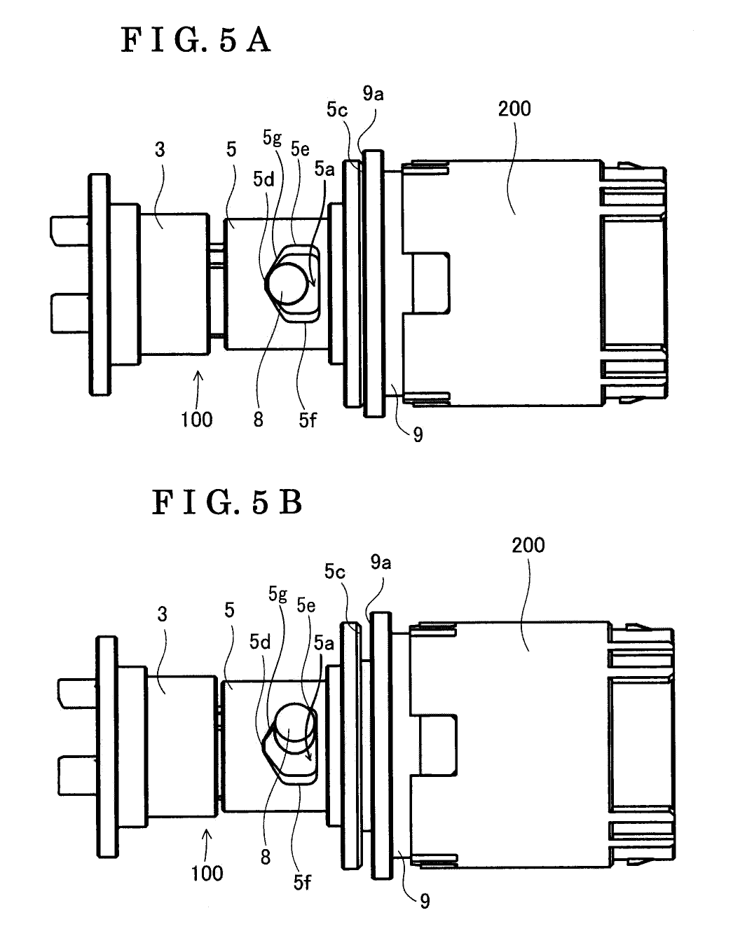

In each of FIGS. 5A and 5B, the spring 4 is not illustrated to clearly show each state of the switching apparatus 100 of the first embodiment in a state where the drive motor 300 is in a stopped state or in a state where the drive motor 300 is in a rotary state.

As shown in FIGS. 5A and 5B, each of the first pin sliding groove 5a of the slider 5 and the second sliding groove of the slider 5 which faces the first pin sliding groove 5a is provided with a first retaining portion 5d and second retaining portions 5e, 5f.

When the drive motor 300 is not in a rotational state, the shaft 7 does not rotate. A contact surface 5c of the slider 5 is in contact with a contact surface 9a of the second stopper 9 by a biasing force of the spring 4. Accordingly, the pin 8 press-fitted into the through hole 7a of the shaft portion 7b of the shaft 7 is retained or held by the first retaining portion 5d. The contact surface 5c of the slider 5 and the contact surface 9a of the second stopper 9 generate contact resistance therebetween so that the slider 5 and the screw 400 are held in a stopped state.

Thus, in a case where the spindle 500 for the powered-back door (PBD) which is provided with the switching apparatus 100 of the embodiment is mounted to the back door (tailgate) of the vehicle, and when the drive motor 300 is not in the rotational state, the heavy door can be stopped desirably regardless of the weight and degree of opening of the vehicle door.

On the other hand, when the drive motor 300 is rotary driven, the shaft 7 rotates. Accordingly, the pin 8 comes to be retained or held by one of the second retaining portions 5e, 5f. The first retaining portion 5d and the second retaining portions 5e, 5f of the first pin sliding groove 5a by which the pin 8 is retained and the first retaining portion 5d and the second retaining portions 5e, 5f of the second pin sliding groove 5b by which the pin 8 is retained are rotational symmetry at 180 degrees relative to a rotary axis X of the shaft 7.

The pin 8 is retained by one of the second retaining portions 5e, 5f and pushes the slider 5 in the axial direction against the biasing force of the spring 4. Accordingly, the slider 5 performs a translational motion in the axial direction against the biasing force of the spring 4. Thus, the contact surface 5c of the slider 5 comes to be away or separated from the contact surface 9a of the second stopper 9. The contact between the contact surface 5c and the contact surface 9a is released so that the slider 5 is rotatable.

Accordingly, the shaft 7 and the pin 8 which is press-fitted and fixed into the through hole 7a of the shaft portion 7b of the shaft 7 rotate. In accordance with the rotation of the shaft 7 and the pin 8, the pin 8 pushes one of the second retaining portions 5e, 5f of the slider 5. Thus, the slider 5, the coupling 3 fitted to the slider 5, and the screw 400 rotate.

Accordingly, in a case where the spindle 500 for the powered-back door (PBD) which is provided with the switching apparatus 100 of the embodiment is mounted to the back door (tailgate) of the vehicle, and when the drive motor 300 is rotary driven, the spindle 500 for the powered-back door (PBD) extends and contracts in accordance with the rotation of the screw 400. Accordingly, the vehicle door can be opened and closed.

When the drive motor 300 stops rotation, the contact surface 5c of the slider 5 comes to be in contact with the contact surface 9a of the second stopper 9 by the biasing force of the spring 4. Accordingly, the pin 8 which is retained by one of the second retaining portions 5e, 5f moves to be retained by the first retaining portion 5d. The contact surface 5c of the slider 5 and the contact surface 9a of the second stopper 9 generate the contact resistance therebetween so that the slider 5 and the screw 400 are retained in the stopped state.

A movement of the switching apparatus 100 according to the first embodiment is based on a principle of a cam mechanism which converts a rotary force of the shaft 7 into a translational force of the slider 5 in the axial direction and which moves the slider 5 in the axial direction. Specifically, the pin 8 press-fitted and fixed to the shaft 7 to rotate therewith moves in the first and second pin sliding grooves 5a, 5b of the slider 5. Each opposing ends of the pin 8 protrudes from the shaft 7. The first and second pin sliding grooves 5a, 5b are formed to face with each other in the radial direction of the slider 5. Each of the first pin sliding grooves 5a, 5b includes the first retaining portion 5d and the second retaining portions 5e, 5f. The first retaining portion 5d is disposed to be away from each of the second retaining portions 5e, 5f in the axial direction of the shaft 7. In other words, the first retaining portion 5d is disposed at a position which includes a predetermined distance from the set of the second retaining portions 5e, 5f in the axial direction of the shaft 7. The first retaining portion 5d is disposed to be away from each of the second retaining portions 5e, 5f in a direction orthogonal to the axial direction of the shaft 7. In other words, the first retaining portion 5d is disposed at a position which includes a predetermined distance from each of the second retaining portions 5e, 5f in the direction orthogonal to the axial direction of the shaft 7. The first retaining portion 5d and each of the second retaining portions 5e, 5f are connected with each other via a cam path 5g. The second retaining portions 5e, 5f are formed to be symmetrical with each other relative to the first retaining portion 5d to correspond to the rotary direction of the shaft 7.

When the shaft 7 is not in a rotational state, the contact surface 5c of the slider 5 and the contact surface 9a of the second stopper 9 are in contact with each other by the biasing force of the spring 4. As shown in FIG. 5A, the pin 8 is retained by the first retaining portion 5d of each of the first and second pin sliding grooves 5a, 5b.

When the shaft 7 is rotary driven, the pin 8 rotates to be retained by one of the second retaining portions 5e, 5f. Accordingly, the slider 5 slidingly moves against the biasing force of the spring 4. Thus, the contact surface 5c of the slider 5 comes to be away or separated from the contact surface 9a of the second stopper 9. Accordingly, the rotary drive of the shaft 7 is transmitted to the screw 400 via, for example, the slider 5 and the coupling 3 so that the spindle 500 for the powered-back door (PBD) extends and contracts.

That is, when the drive motor 300 rotates, the pin 8 which is press-fitted and fixed into the through hole 7a of the shaft portion 7b of the shaft 7 climbs over, or overrides and slides on the cam path 5g from the first retaining portion 5d of the first pin sliding groove 5a (the second pin sliding groove 5b) of the slider 5 in accordance with the rotation of the shaft 7. Then, the pin 8 engages with one of the second retaining portions 5e, 5f. The pin 8 climbs over, or overrides and slides on the cam path 5g and engages one of the second retaining portions 5e, 5f so that the pin 8 pushes the slider 5 against the biasing force of the spring 4. Accordingly, the slider 5 performs the translational motion in the axial direction against the biasing force of the spring 4. Thus, the contact surface 5c of the slider 5 is away or separated from the contact surface 9a of the second stopper 9. Because the contact between the contact surface 5c and the contact surface 9a is released, the slider 5 can rotate smoothly.

According to the switching apparatus 100 of the first embodiment, the pin 8 fixed to the shaft 7 is retained by the first retaining portion 5d or by one of the second retaining portions 5e, 5f of the first pin sliding groove 5a (the second sliding groove 5b) of the slider 5. Alternatively, a cam mechanism can be formed by the pin 8 which is fixed to the slider 5 and the shaft 7 which is formed with first and second pin sliding grooves having first and second retaining portions.

According to the switching apparatus 100 of the first embodiment, the shaft 7 and the screw 400 rotate in accordance with the rotary drive of the drive motor 300. Alternatively, when the coupling 3 is rotated by a manual operation, the switching apparatus 100 is switched to be in a rotary state by the operation of the cam mechanism of the switching apparatus 100. Thus, in a case where the spindle 500 for the powered-back door (PBD) which is provided with the switching apparatus 100 of the embodiment is mounted to the back door (tailgate) of the vehicle, and when the back door is opened and closed by the manual operation, the coupling 3 rotates in accordance with the rotation of the screw 400. Accordingly, the switching apparatus 100 is switched to be in the rotary state to open and close the back door by the manual operation.

As described above, in a case where the spindle 500 for the powered-back door (PBD) which is provided with the switching apparatus 100 of the embodiment is mounted to the back door (tailgate) of the vehicle, the heavy door can be stopped desirably regardless of the weight and degree of opening of the vehicle door. In addition, the back door can be opened and closed by the manual operation.

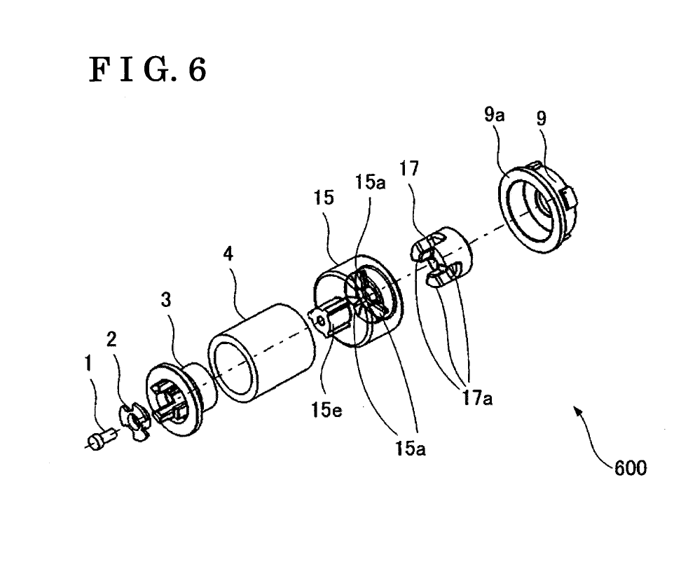

Next, a switching apparatus 600 of a second embodiment will be explained with reference to FIGS. 6 to 9.

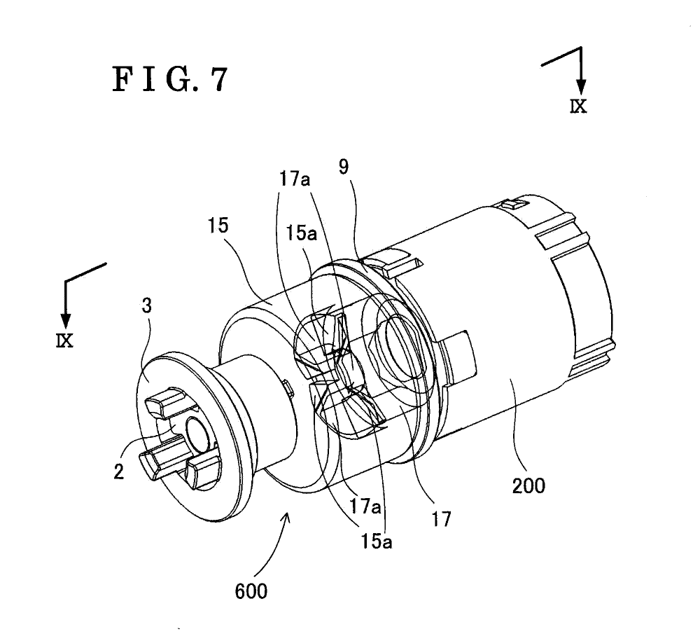

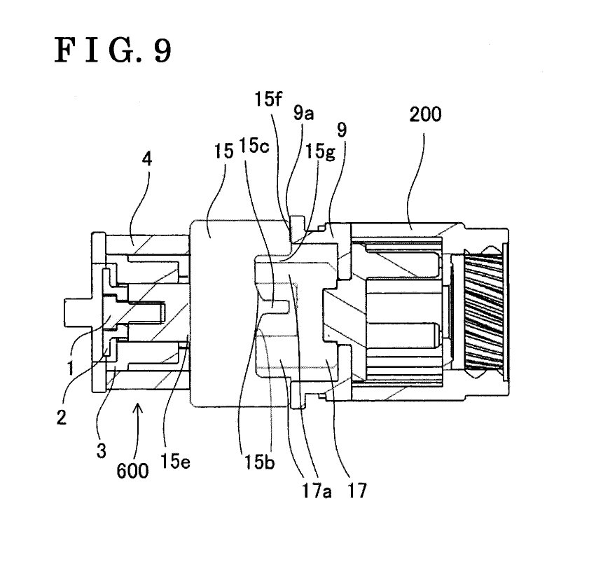

In each of FIGS. 7 and 9, the planetary gear mechanism 200 connected to the switching apparatus 600 is illustrated. In each of FIGS. 6 and 7, respective internal structures of a slider 15 and a shaft 17 are illustrated in a perspective view.

Instead of the slider 5 and the shaft 7 of the switching apparatus 100 of the first embodiment, the switching apparatus 600 is provided with the slider 15 and the shaft 17 (i.e., serving as a rotary member). For convenience of description, the same components as those described in the first embodiment are marked with the same reference numerals, and description of the components will not be repeated.

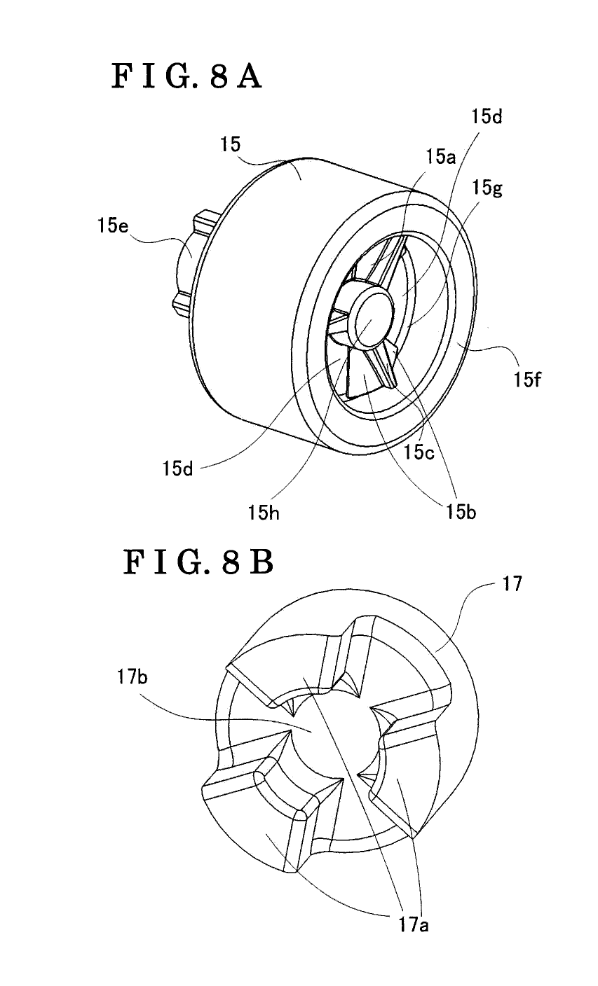

As shown in FIG. 8A, the slider 15 is provided with a first shaft portion 15e connected to the coupling 3 and a recessed portion 15g (i.e., serving as a pawl portion receiving portion) disposed opposite the first shaft portion 15e. The recessed portion 15g is provided with three base portions 15d and three protruding portions 15a around a second shaft portion 15h which is placed at a center portion of the slider 15. The protruding portion 15a protrudes relative to the base portion 15d in the axial direction. The protruding portion 15a is provided with a wall portion 15c and inclination portions 15b (i.e., serving as a cam path). The wall portion 15c is disposed at a center portion of the protruding portion 15a. The inclination portions 15b are provided at opposing ends of the protruding portion 15a to sandwich the wall portion 15c. Each of the protruding portions 15a is disposed between the base portions 15d and is disposed to be equally spaced with each other in a circumferential direction of the slider 15. As such, the protruding portion 15a and the base portion 15d are disposed alternately in the circumferential direction. The wall portion 15c and the base portion 15d are connected with each other by the inclination portion 15b which serves as a ramp way. In particular, the inclination portion 15b is formed such that a portion of the inclination portion 15b close to the base portion 15d includes a slope in an axial direction of the shaft 17 and in a direction orthogonal to the axial direction of the shaft 17 relative to a portion of the inclination portion 15b close to the wall portion 15c. Thus, the inclination portion 15b is formed with a cam path which is shaped as the ramp way. In other words, the inclination portion 15b is formed such that the portion of the inclination portion 15b close to the base portion 15d includes a positional displacement along the axial direction relative to the portion of the inclination portion 15b close to the wall portion 15c along the axial direction. The first shaft portion 15e performs the same function as the shaft portion 5j of the slider 5 of the switching apparatus 100.

As shown in FIG. 8B, the shaft 17 includes three pawl portions 17a (i.e., serving as a transmission member) disposed to be equally spaced with each other in a circumferential direction of the shaft 17 about a recessed portion 17b which is placed at a center portion of the shaft 17. The shaft 17 is fixed to the planetary gear mechanism 200.

The second shaft portion 15h provided at the recessed portion 15g of the slider 15 is disposed within the recessed portion 17b of the shaft 17 so that the slider 15 and the shaft 17 of the switching apparatus 600 according to the second embodiment are connected with each other. According to the switching apparatus 600 of the second embodiment, the slider 15 is provided with the three base portions 15d and the three protruding portions 15a. The shaft 17 is provided with the three pawl portions 17a which correspond to the construction of the slider 15. Alternatively, the number of base portions 15d, protruding portions 15a, and pawl portions 17a is not limited to three and may be any number, for example, less than two or more than four. The number of pawl portions 17a may be less than the number of base portions.

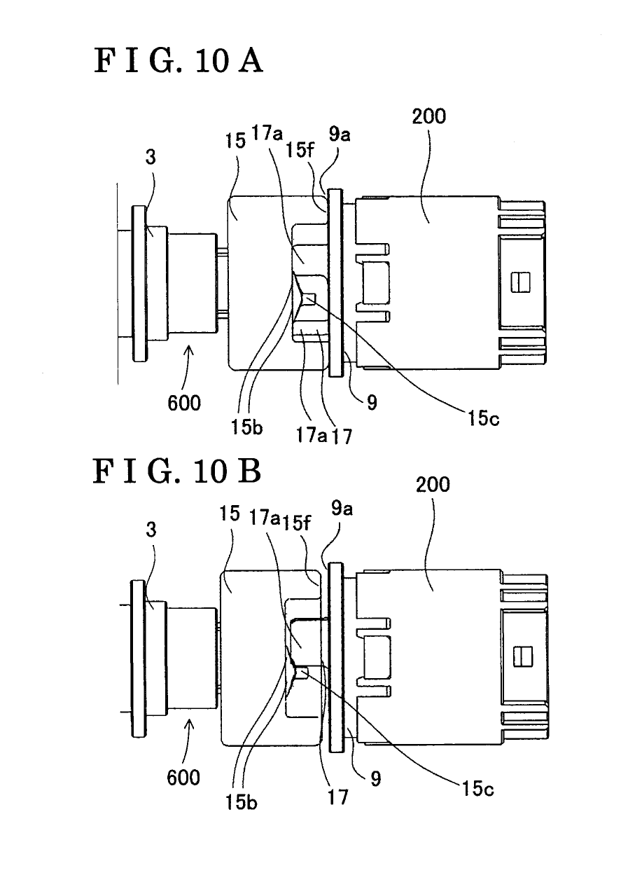

Each state of the switching apparatus 600 of the second embodiment in a state where the drive motor 300 is in the stopped state or in a state where the drive motor 300 is in the rotary state will be described with reference to FIGS. 10A and 10B. The spring 4 is not illustrated to show the motion of the switching apparatus 600 clearly.

When the drive motor 300 is not in the rotational state, the shaft 17 does not rotate. The contact surface 15f of the slider 15 is in contact with the contact surface 9a of the second stopper 9 by the biasing force of the spring 4. The pawl portion 17a of the shaft 17 is placed at the base portion 15d of the slider 15. The contact surface 15f of the slider 15 and the contact surface 9a of the second stopper 9 generate contact resistance therebetween so that the slider 15 and the screw 400 are retained in the stopped state.

Thus, in a case where the spindle 500 for the powered-back door (PBD) which is provided with the switching apparatus 600 of the second embodiment is mounted to the back door (tailgate) of the vehicle, and when the drive motor 300 is not in the rotational state, the screw 400 is retained in the stopped state. Thus, the heavy door can be stopped desirably regardless of the weight and degree of opening of the vehicle door.

When the drive motor 300 is rotary driven, the pawl portion 17a of the shaft 17 climbs over, or overrides and slides on the inclination portion 15b of the slider 15 from the base portion 15d in accordance with the rotation of the shaft 17. Then, the pawl portion 17a of the shaft 17 engages with the wall portion 15c of the slider 15. The pawl portion 17a of the shaft 17 climbs over, or overrides and slides on the inclination portion 15b of the slider 15 and engages with the wall portion 15c of the slider 15 so that the pawl portion 17a presses the slider 15 in the axial direction against the biasing force of the spring 4. Accordingly, the slider 15 performs the translational motion in the axial direction against the biasing force of the spring 4. Thus, the contact surface 15f of the slider 15 is away or separated from the contact surface 9a of the second stopper 9. The contact between the contact surface 15f and the contact surface 9a is released so that the slider 15 can rotate smoothly.

The pawl portion 17a engages with the wall portion 15c of the slider 15 in accordance with the rotation of the shaft 17 and the pawl portion 17a of the shaft 17 so that the slider 15, the coupling 3 which is fitted to the slider 15, and the screw 400 rotate.

Thus, in a case where the spindle 500 for the powered-back door (PBD) which is provided with the switching apparatus 600 of the second embodiment is mounted to the back door (tailgate) of the vehicle, and when the drive motor 300 is rotary driven, the screw 400 rotates. Accordingly, the spindle 500 for the powered-back door (PBD) extends and contracts to open and close the vehicle door.

When the drive motor 300 stops rotation, the pawl portion 17a of the shaft 17 engaging with the wall portion 15c of the slider 15 moves from the wall portion 15c to the base portion 15d and is placed at the base portion 15d by the biasing force of the spring 4. In those circumstances, the contact surface 15f of the slider 15 comes to be in contact with the contact surface 9a of the second stopper 9. The contact surface 15f of the slider 15 and the contact surface 9a of the second stopper 9 generate the contact resistance therebetween so that the slider 15 and the screw 400 are retained in the stopped state.

A movement of the switching apparatus 600 according to the second embodiment is based on a principle of a cam mechanism which converts a rotary force of the shaft 17 into a translational force of the slider 15 in the axial direction and which moves the slider 15 in the axial direction. Specifically, the pawl portion 17a of the shaft 17 moves between the base portion 15d of the slider 15 and the wall portion 15c of the slider 15. The pawl portion 17a of the shaft 17 is formed to be disposed within the recessed portion 15g of the slider 15. The recessed portion 15g is provided with the base portions 15d and the protruding portions 15a about the second shaft portion 15h which is placed at the center portion of the slider 15. The protruding portion 15a is provided with the wall portion 15c and the inclination portions 15b. The wall portion 15c is disposed at the center portion of the protruding portion 15a. The inclination portions 15b are provided at the opposing ends of the protruding portion 15a to sandwich the wall portion 15c. Each of the protruding portions 15a is disposed between the base portions 15d and is disposed to be equally spaced with each other in the circumferential direction of the slider 15. The base portion 15d and the wall portion 15c are connected with each other by the inclination portions 15b (cam path) which serve as the ramp ways. In other words, the inclination portion 15b is shaped as the ramp way which includes an inclined slope disposed from the base portions 15d toward the wall portion 15c.

When the shaft 17 is not in a rotational state, the contact surface 15f of the slider 15 and the contact surface 9a of the second stopper 9 are in contact with each other by the biasing force of the spring 4. As shown in FIG. 10A, the pawl portion 17a of the shaft 17 is in contact with the base portion 15d of the slider 15.

When the shaft 17 is rotary driven, as shown in FIG. 10B, the pawl portion 17a of the shaft 17 slides on the inclination portion 15b which serves as the ramp way and engages with the wall portion 15c of the slider 15 in accordance with the rotation of the shaft 17. In those circumstances, the slider 15 slidingly moves in the axial direction against the biasing force of the spring 4 so that the contact surface 15f of the slider 15 comes to be away or separated from the contact surface 9a of the second stopper 9. The rotary drive of the shaft 17 is transmitted to the screw 400 via, for example, the slider 15 and the coupling 4. Accordingly, the spindle 500 for the powered-back door (PBD) extends and contracts. According to the switching apparatus 600 of the second embodiment, the protruding portion 15a of the slider 15 includes the inclination portions 15b disposed at opposing ends of the protrusion 15a and the base portions 15d disposed at opposing ends of the protrusion 15a which sandwich the wall portion 15c which is placed at the intermediate portion of the slider 15. Accordingly, the aforementioned cam mechanism is operated in a case where the shaft 17 rotates in either direction. In addition, because the cam mechanism is constructed with the inclination portion 15b of the slider 15, the wall portion 15c of the slider 15 and the pawl portion 17a of the shaft 17, the cam mechanism may be provided with a simple configuration without additional components. Because the inclination portion 15b of the slider 15, the wall portion 15c of the slider 15 and the pawl portion 17a of the shaft 17 can be formed with the process which is operated from a single direction in the axial direction, the manufacturing cost can be reduced. In a case where the pawl portion 17a of the shaft 17 slides relative to the inclination portion 15b of the slider 15, the inclination portion 15b and the pawl portion 17a come to be in surface contact with each other. Accordingly, the rotary force of the shaft 17 can be transmitted to the slider 15 further reliably.

According to the switching apparatus 600 of the second embodiment, the pawl portion 17a of the shaft 17 slides on the inclination portion 15b of the protruding portion 15a of the slider 15 and engages with the wall portion 15c. Alternatively, the slider 15 can include a pawl portion while the shaft 17 can include inclination portions serving as the ramp ways and a wall portion to form a cam mechanism.

According to the switching apparatus 600 of the second embodiment, the shaft 17 and the screw 400 rotates in accordance with the rotary drive of the drive motor 300. Alternatively, the cam mechanism of the switching apparatus 600 is operated to convert the switching apparatus 600 into the rotary state in a case where the coupling 3 rotates by the manual operation. Thus, in a case where the spindle 500 for the powered-back door (PBD) which is provided with the switching apparatus 600 of the second embodiment is mounted to the back door (tailgate) of the vehicle, and when the back door is opened and closed by the manual operation, the coupling 3 rotates in accordance with the rotation of the screw 400. Accordingly, the switching apparatus 600 is converted into the rotary state to open and close the back door by the manual operation.

Thus, in a case where the spindle 500 for the powered-back door (PBD) which is provided with the switching apparatus 600 of the second embodiment is mounted to the back door (tailgate) of the vehicle, the heavy door can be stopped desirably regardless of the weight and degree of opening of the vehicle door. In addition, the vehicle door can be opened and closed by the manual operation.

This disclosure is not limited to the aforementioned cam mechanism. Other mechanisms are applicable as long as mechanisms can convert a rotary force of a rotary member into a translational force of a slider in an axial direction.

The switching apparatuses 100, 600 of the first and second embodiments are mounted to the spindle for the powered-back door (PBD). Alternatively, the switching apparatuses 100, 600 are applicable for opening and closing a sliding door of the vehicle or a window of the vehicle and for raising and lowering the vehicle seat.

According to the aforementioned embodiment, the rotation and stop retention switching apparatus 100, 600 includes the rotary member (the shaft 7, 17) being rotary driven, the slider 5, 15 being movable in the axial direction of the rotary axis X of the rotary member (the shaft 7, 17), the transmission member (the pin 8, the pawl portion 17a) transmitting the rotary force of the rotary member (the shaft 7, 17) to the slider 5, 15 and converting the rotary force of the rotary member (the shaft 7, 17) into the translational force of the slider 5, 15 in the axial direction of the rotary axis X, the biasing member (the spring 4) biasing the slider 5, 15 in the axial direction of the rotary axis X, and the stopper member (the second stopper 9) coming in contact with the slider 5, 15 being biased by the biasing member (the spring 4). The rotary force of the rotary member (the shaft 7, 17) is transmitted to the slider 5, 15 via the transmission member (the pin 8, the pawl portion 17a) in a state where the slider 5, 15 is disengaged from the stopper member (the second stopper 9) by the movement of the slider 5, 15 in the axial direction of the rotary axis X, the movement caused by the translational force of the slider 5, 15 with the use of the transmission member (the pin 8, the pawl portion 17a) against the biasing force of the biasing member (the spring 4).

According to the aforementioned embodiments, the rotation and stop retention switching apparatus 100, 600 can retain the vehicle door in the stopped state in a case where the rotation and stop retention switching apparatus 100, 600 is mounted to the spindle 500 for the powered-back door (PBD). Accordingly, the lead length of the screw 400 can be long to increase the opening and closing speed of the vehicle door.

According to the rotation and stop retention switching apparatus 100, 600 of the embodiments, the contact resistance between the respective contact surfaces of the slider 5, 15 and the second stopper 9 can be released completely by the rotation of the shaft 7, 17. Accordingly, the output of the rotary force does not decrease. In addition, the drive motor does not need to be upsized if used.

According to the rotation and stop retention switching apparatus 100, 600 of the embodiments, the quantitative resistance can be predicted because the resistance is generated between the respective contact surfaces of the slider 5, 15 and the second stopper 9 by the biasing force of the spring 4 in the axial direction. In addition, the slider 5, 15 and the spring 4 are disposed next to each other in the radial direction so that the rotation and stop retention switching apparatus 100 can be prevented from upsizing in the axial direction of the rotary axis X.

According to the aforementioned embodiment, the transmission member (the pin 8, the pawl portion 17a) includes the cam mechanism (the slider 5, 15, the shaft 7, 17, the pin 8) being provided at the slider 5, 15 and the rotary member (the shaft 7, 17).

According to the aforementioned embodiment, the biasing member (the spring 4) is formed in the hollow structure. The biasing member (the spring 4) extends in the axial direction of the rotary axis X. The slider 5, 15 is disposed to be inserted into the biasing member (the spring 4).

According to the aforementioned embodiment, the cam mechanism (the slider 5, the shaft 7, the pin 8) includes the pin 8 being fixed to one of the rotary member (the shaft 7) and the slider 5. The pin 8 extends in the radial direction of the rotary member (the shaft 7), the cam mechanism (the slider 5, the shaft 7, the pin 8) includes the pin receiving portion (the pin sliding groove 5a, 5b) being disposed at the other of the rotary member (the shaft 7) and the slider 5. The pin receiving portion (the pin sliding groove 5a, 5b) receives the pin 8. The pin receiving portion (the pin sliding groove 5a, 5b) includes the first retaining portion 5d retaining the pin 8 when the rotary member (the shaft 7) is not in the rotational state. The pin receiving portion (the pin sliding groove 5a, 5b) includes the second retaining portion 5e, 5f retaining the pin 8 when the rotary member (the shaft 7) is rotary driven. The pin receiving portion (the pin sliding groove 5a, 5b) includes the cam path 5g connecting the first retaining portion 5d and the second retaining portion 5e, 5f. The rotary force of the rotary member (the shaft 7) is transmitted to the slider 5 via the pin 8 in a state where the slider 5 is disengaged from the stopper member (the second stopper 9) by the movement of the slider 5 in the axial direction of the rotary axis X, the movement caused by the pin 8 being retained by the first retaining portion 5d and moving along the cam path 5g to be retained by the second retaining portion 5e, 5fi when the rotary member (the shaft 7) is rotary driven.

According to the aforementioned embodiment, the cam mechanism (the slider 15, the shaft 17) includes the pawl portion 17a being disposed at one of the rotary member (the shaft 17) and the slider 15. The cam mechanism (the slider 15, the shaft 17) includes the pawl portion receiving portion (the recessed portion 15g) being disposed at the other of the rotary member (the shaft 17) and the slider 15, the pawl portion receiving portion (the recessed portion 15g) receiving the pawl portion 17a. The pawl portion receiving portion (the recessed portion 15g) includes the base portion 15d at which the pawl portion 17a is disposed when the rotary member (the shaft 17) is not in the rotational state. The pawl portion receiving portion (the recessed portion 15g) includes the wall portion 15c with which the pawl portion 17a engages when the rotary member (the shaft 17) is rotary driven. The base portion 15d and the wall portion 15c are disposed along the circumferential direction of the rotary member (the shaft 17). The base portion 15d and the wall portion 15c are connected with each other by the cam path (the inclination portions 15b). The rotary force of the rotary member (the shaft 17) is transmitted to the slider 15 via the pawl portion 17a in a state where the slider 15 is disengaged from the stopper member (the second stopper 9) by the movement of the slider 15 in the axial direction of the rotary axis X, the movement caused by the pawl portion 17a being disposed at the base portion 15d and sliding along the cam path (the inclination portions 15b) to be engaged with the wall portion 15c when the rotary member (the shaft 17) is rotary driven.

According to the aforementioned embodiment, the spindle 500 includes the rotation and stop retention switching apparatus 100, 600 including the rotary member (the shaft 7, 17) being rotary driven, the slider 5, 15 being movable in the axial direction of the rotary axis X of the rotary member (the shaft 7, 17), the transmission member (the pin 8, the pawl portion 17a) transmitting the rotary force of the rotary member (the shaft 7, 17) to the slider 5, 15 and converting the rotary force of the rotary member (the shaft 7, 17) into the translational force of the slider 5, 15 in the axial direction of the rotary axis X, the biasing member (the spring 4) biasing the slider 5, 15 in the axial direction of the rotary axis X, and the stopper member (the second stopper 9) coming in contact with the slider 5, 15 being biased by the biasing member (the spring 4). The rotary force of the rotary member (the shaft 7, 17) is transmitted to the slider 5, 15 via the transmission member (the pin 8, the pawl portion 17a) in a state where the slider 5, 15 is disengaged from the stopper member (the second stopper 9) by the movement of the slider 5, 15 in the axial direction of the rotary axis X, the movement caused by the translational force of the slider 5, 15 with the use of the transmission member (the pin 8, the pawl portion 17a) against the biasing force of the biasing member (the spring 4). The spindle 500 further includes the screw 400 being connected to the slider 5, 15.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotation and stop retention switching apparatus, comprising:
a rotary member being rotary driven;
a slider being movable in an axial direction of a rotary axis of the rotary member;
a transmission member transmitting a rotary force of the rotary member to the slider and converting the rotary force of the rotary member into a translational force of the slider in the axial direction of the rotary axis;
a biasing member biasing the slider in the axial direction of the rotary axis; and
a stopper member coming in contact with the slider being biased by the biasing member; wherein;
the rotary force of the rotary member is transmitted to the slider via the transmission member in a state where the slider is disengaged from the stopper member by a movement of the slider in the axial direction of the rotary axis, the movement caused by the translational force of the slider with a use of the transmission member against a biasing force of the biasing member.

2. The rotation and stop retention switching apparatus according to claim 1, wherein the transmission member includes a cam mechanism being provided at the slider and the rotary member.

3. The rotation and stop retention switching apparatus according to claim 2, wherein
the biasing member is formed in a hollow structure, the biasing member extends in the axial direction of the rotary axis; and
the slider is disposed to be inserted into the biasing member.

4. The rotation and stop retention switching apparatus according to claim 2, wherein
the cam mechanism includes a pin being fixed to one of the rotary member and the slider, the pin extending in a radial direction of the rotary member, the cam mechanism includes a pin receiving portion being disposed at the other of the rotary member and the slider, the pin receiving portion receiving the pin;
the pin receiving portion includes a first retaining portion retaining the pin when the rotary member is not in a rotational state, the pin receiving portion includes a second retaining portion retaining the pin when the rotary member is rotary driven, the pin receiving portion includes a cam path connecting the first retaining portion and the second retaining portion; and
the rotary force of the rotary member is transmitted to the slider via the pin in a state where the slider is disengaged from the stopper member by a movement of the slider in the axial direction of the rotary axis, the movement caused by the pin being retained by the first retaining portion and moving along the cam path to be retained by the second retaining portion when the rotary member is rotary driven.

5. The rotation and stop retention switching apparatus according to claim 2, wherein
the cam mechanism includes a pawl portion being disposed at one of the rotary member and the slider; the cam mechanism includes a pawl portion receiving portion being disposed at the other of the rotary member and the slider, the pawl portion receiving portion receiving the pawl portion;
the pawl portion receiving portion includes a base portion at which the pawl portion is disposed when the rotary member is not in a rotational state; the pawl portion receiving portion includes a wall portion with which the pawl portion engages when the rotary member is rotary driven; the base portion and the wall portion are disposed along a circumferential direction of the rotary member; the base portion and the wall portion are connected with each other by a cam path; and
the rotary force of the rotary member is transmitted to the slider via the pawl portion in a state where the slider is disengaged from the stopper member by a movement of the slider in the axial direction of the rotary axis, the movement caused by the pawl portion being disposed at the base portion and sliding along the cam path to be engaged with the wall portion when the rotary member is rotary driven.

6. A spindle, comprising:
a rotation and stop retention switching apparatus including
a rotary member being rotary driven;
a slider being movable in an axial direction of a rotary axis of the rotary member;
a transmission member transmitting a rotary force of the rotary member to the slider and converting the rotary force of the rotary member into a translational force of the slider in the axial direction of the rotary axis;
a biasing member biasing the slider in the axial direction of the rotary axis; and
a stopper member coming in contact with the slider being biased by the biasing member; wherein;
the rotary force of the rotary member is transmitted to the slider via the transmission member in a state where the slider is disengaged from the stopper member by a movement of the slider in the axial direction of the rotary axis, the movement caused by the translational force of the slider with a use of the transmission member against a biasing force of the biasing member; and
a screw being connected to the slider.

7. The spindle including the rotation and stop retention switching apparatus according to claim 6, wherein the transmission member includes a cam mechanism being provided at the slider and the rotary member.

8. The spindle including the rotation and stop retention switching apparatus according to claim 7, wherein
the biasing member is formed in a hollow structure, the biasing member extends in the axial direction of the rotary axis; and
the slider is disposed to be inserted into the biasing member.

9. The spindle including the rotation and stop retention switching apparatus according to claim 7, wherein
the cam mechanism includes a pin being fixed to one of the rotary member and the slider, the pin extending in a radial direction of the rotary member, the cam mechanism includes a pin receiving portion being disposed at the other of the rotary member and the slider, the pin receiving portion receiving the pin;
the pin receiving portion includes a first retaining portion retaining the pin when the rotary member is not in a rotational state, the pin receiving portion includes a second retaining portion retaining the pin when the rotary member is rotary driven, the pin receiving portion includes a cam path connecting the first retaining portion and the second retaining portion; and
the rotary force of the rotary member is transmitted to the slider via the pin in a state where the slider is disengaged from the stopper member by a movement of the slider in the axial direction of the rotary axis, the movement caused by the pin being retained by the first retaining portion and moving along the cam path to be retained by the second retaining portion when the rotary member is rotary driven.

10. The spindle including the rotation and stop retention switching apparatus according to claim 7, wherein
the cam mechanism includes a pawl portion being disposed at one of the rotary member and the slider; the cam mechanism includes a pawl portion receiving portion being disposed at the other of the rotary member and the slider, the pawl portion receiving portion receiving the pawl portion;
the pawl portion receiving portion includes a base portion at which the pawl portion is disposed when the rotary member is not in a rotational state; the pawl portion receiving portion includes a wall portion with which the pawl portion engages when the rotary member is rotary driven; the base portion and the wall portion are disposed along a circumferential direction of the rotary member; the base portion and the wall portion are connected with each other by a cam path; and
the rotary force of the rotary member is transmitted to the slider via the pawl portion in a state where the slider is disengaged from the stopper member by a movement of the slider in the axial direction of the rotary axis, the movement caused by the pawl portion being disposed at the base portion and sliding along the cam path to be engaged with the wall portion when the rotary member is rotary driven.
